(19) United States
(12) Patent Application Publication
(10) Pub. No.: US 2005/0056109 A1
(43) Pub. Date: Mar. 17, 2005

(54) Shifting device for a shift-by-wire system

(76) Inventor: Seung Hoon Kim, Gimpo-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,893

(22) Filed: Dec. 29, 2003

(30) Foreign Application Priority Data
Aug. 27, 2003 (KR) 10-2003-0059588

(51) Int. Cl. B60K 20/00; F16H 59/00

(52) U.S. Cl. 74/473.3

(57) ABSTRACT

A shifting device for a shift-by-wire system is provided which comprises a shift lever and a shift mode switch unit. The shift lever comprises a head portion and a shifting portion that is coupled to the head portion. The shifting portion is shifted into each of shift range positions. The shift lever is configured to output a corresponding electric signal in response to a shifting of the shifting portion. The shift mode switch unit is coupled to the head portion of the shift lever, and it is configured to change a shift mode according to a state of a connection to the shift lever.

### CROSS-REFERENCE TO RELATED APPLICATIONS

This application claims priority of Korean Application No. 10-2003-0059588, filed on Aug. 27, 2003, the disclosure of which is incorporated fully herein by reference.

### FIELD OF THE INVENTION

The present invention relates to a shifting device for a shift-by-wire system for a vehicle.

### BACKGROUND OF THE INVENTION

Generally, steering and braking systems of a vehicle are based on mechanical systems. For example, the steering system is driven by a driver's manipulation of a steering wheel, and the braking system is driven by a driver's depression of a brake pedal.

Recently, X-by-wire technologies have been developed. In the X-by-wire system, mechanical connections such as a cable, a rod, and a hydraulic connection are substituted with electrical connections (e.g., wire connection). Such X-by-wire technology can be applied to the steering system or a braking system.

In a vehicle having an automatic transmission, a shift lever for selecting a shift range among several ranges including a parking P range, a reverse R range, a neutral N range, and a driving D range is mechanically connected to the automatic transmission. For example, the shift lever is connected to a manual valve of the automatic transmission through a manual control cable, a manual control lever, and a manual control shaft.

The conventional shifting device has the following problems. In a rear wheel drive vehicle, the manual control cable is long, so that the shift feeling is deteriorated. Furthermore, a position of the shift lever is substantially restricted to a certain position because of the connection to the transmission, so there is little design freedom for the shift lever.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

An embodiment of the present invention provides a shifting device that is small and can easily select a shift range.

In a preferred embodiment of the present invention, the shifting device for a shift-by-wire system comprises a shift lever and a shift mode switch unit. The shift lever comprises a head portion and a shifting portion that is coupled to the head portion. The shifting portion is shifted into each of shift range positions. The shift lever is configured to output a corresponding electric signal in response to a shifting of the shifting portion. The shift mode switch unit is coupled to the head portion of the shift lever, and it is configured to change a shift mode according to a state of a connection to the shift lever.

It is preferable that the shift mode switch unit is provided with a park button for realizing a park-by-wire function.

It is also preferable that the head portion of the shift lever is provided with a shift range indicating lamp showing a current shift range.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 shows a shifting device according to the preferred embodiment of the present invention;

FIG. 2 shows a mounting position of the shifting device according to the embodiment of the present invention; and

FIG. 3 shows states of the shifting device in an automatic shift mode, a manual shift mode, and a park mode.

### DETAILED DESCRIPTION OF THE PREFERRED EMBODIMENTS

Hereinafter, a preferred embodiment of the present invention will be described in detail with reference to the accompanying drawings.

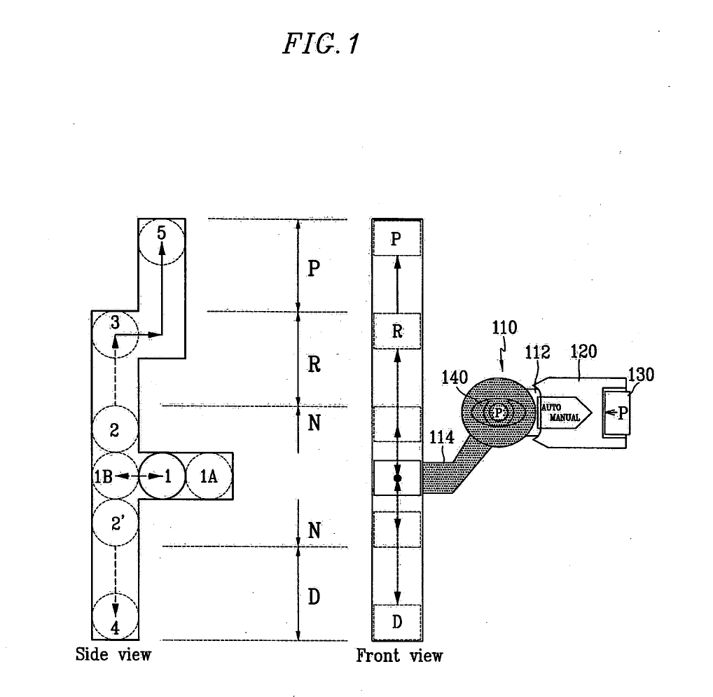

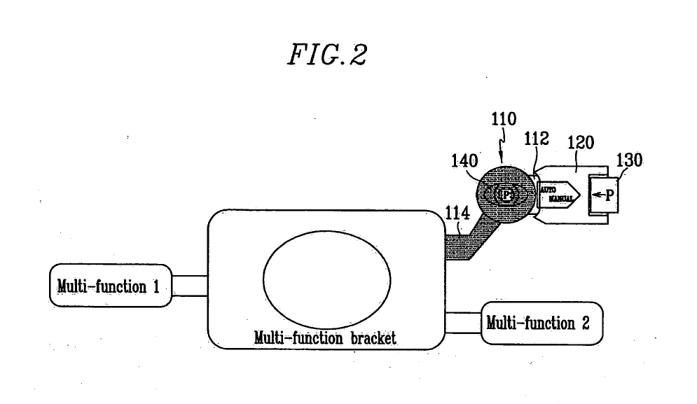

As shown in FIGS. 1 and 2, the shifting device according to the embodiment of the present invention includes a shift lever 110 and a shift mode switch unit 120.

As shown in FIG. 2, the shift lever 110 is preferably mounted on a multi-function bracket on the windshield side of a steering wheel, for convenience of manipulation and for efficient use of a vehicle interior.

The shift lever 110 includes a head portion 112 and a shifting portion 114 that is coupled to the head portion 112. The shifting portion is shifted into each of shift range positions by an external force transmitted to the head portion 112.

The shift lever 110 is configured to output a corresponding electric signal in response to the shifting movements of the shifting portion 114. As an example, the shift lever 110 may include an electric circuit for outputting the corresponding signal in response to the shifting movements of the shifting portion 114.

The shift mode switch unit 120, as shown in FIGS. 1 to 3, is slidably connected to the head portion 112 of the shift lever 110. The shift mode switch unit 120 is configured to change a shift mode according to a state of connection to the shift lever 110. The shift modes are an automatic shift mode, a manual shift mode (i.e., a sports mode), and a parking mode. In the automatic shift mode, a shift speed is automatically determined, and in the manual shift mode, an up-shift or a down-shift can be performed by an operation of the shift lever 110. In the parking mode, a parking brake operates.

The shift mode switch unit 120 is provided with a park button 130 for realizing a park-by-wire function. If the park button 130 is depressed, the parking mode is selected so that a corresponding signal is generated and a corresponding operation is performed. Therefore, the shifting device according to the embodiment of the present invention can realize both the shift-by-wire and the park-by-wire functions.

A shift range indicating lamp 140 is disposed in the head portion 112 of the shift lever 110, and it shows a shifting state, e.g., a current shift range. The shift range indicating lamp 140 is configured to show one of P, R, N, and D, so a driver can easily perceive the currently selected shift range from the shift range indicating lamp 140.

According to the embodiment of the present invention, as opposed to the conventional shift system in which a shifting operation is performed through a mechanical link, the shifting is performed by electrical signals generated corresponding to the manipulation of the shift lever 110 and the shift mode switch unit 120.

Referring to FIGS. 1 to 3, the manipulations of the shifting device according to the shift mode will be explained.

In the automatic mode, the manipulations of the shifting device are as follows.

In the automatic mode, the shift range indicating lamp 140 shows a signal indicating the automatic mode (e.g., AUTO), and one of the R range, the N range, and the D range can be selected.

For example, referring to FIG. 1, if the shift lever 110 is moved from a position “1” (N range position) to a position “3” (R range position) by moving the shift lever 110 from the position “1” to a position “1B” and then to the position “3”, the shift range is changed from the neutral N range to the reverse R range. If the shift lever 110 is released at the position “3”, the shift lever 110 is automatically returned to the position “1”.

Referring to FIG. 1, if the shift lever 110 is moved from the position “1” to a position “4” (D range position) by moving the shift lever 110 from the position “1” to the position “1B” and then to the position “4”, the shift range is changed from the neutral N range to the drive D range. If the shift lever 110 is released at the position “4”, the shift lever 110 is automatically returned to the position “1”.

Referring to FIG. 1, changes of the shift range from the reverse R range or the drive D range to the neutral N range will be explained. By moving the shift lever 110 from the position “1” to the position “1B” and then maintaining the shift lever 110 at the position “1B” for two seconds, or by moving the shift lever 110 from the position “1” to the position “1B” and then to a position “2” or a position “2′” (N range position), the shift range can be changed from the reverse R range or the drive D range to the neutral N range. If the shift lever 110 is released at the position “2” or “2′”, the shift lever 110 is automatically returned to the position “1”.

Manipulations of the shifting device in the manual mode will now be explained.

In the manual mode, the shift range indicating lamp 140 shows a signal indicating the manual mode (e.g., MANUAL). The manual mode can be selected by moving the shift mode switch unit 120 in a rightward direction in the drawings. The manual mode can be selected only when the shift range is the drive D range in the automatic mode.

Referring to FIG. 1, an up-shift and a down-shift in the manual mode will be explained.

If the shift lever 110 is moved from the position “1” to the position “1B”, a down-shift signal is generated. If the shift lever 110 is released at the position “1B”, the shift lever 110 is returned to the position “1”. In addition, if the shift lever 110 is moved from the position “1” to a position “1A”, an up-shift signal is generated, and if the shift lever 110 is released at the position “1A”, the shift lever 110 is returned to the position “1”.

Hereinafter, manipulations of the shifting device in the park mode will be explained.

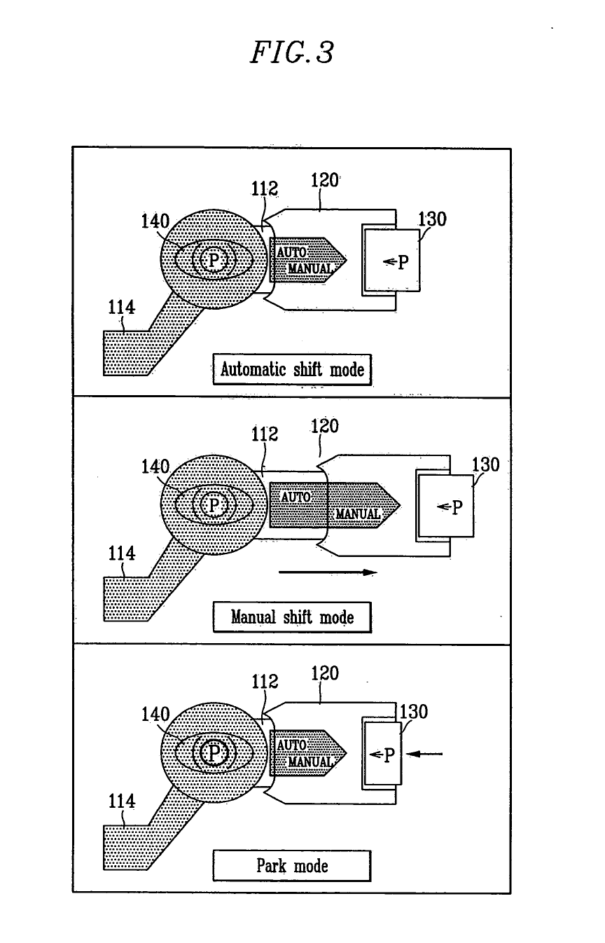

As shown in FIG. 3, if the park button 130 is pushed, the park mode is selected. In the park mode, the shift range indicating lamp 140 shows a signal indicating the park mode (e.g., PARK). In the park mode, a parking brake is controlled to operate. At this time, a conventional parking brake indicating lamp of a cluster can be used to show the park mode. The park button 130 is a device for realizing a park-by-wire function.

In this embodiment, an initial position of the shift lever 110 is a position “5” (P range position). This position corresponds to a P-lock of a conventional system.

If the shift lever 110 is moved from the initial position “5” to the position “3” and released, it is then automatically returned to the position “1” as stated in the above. The shift lever 110 is configured to move from the position “5” to the position “3” only when a brake pedal is depressed, to realize a shift lock.

If the shift lever 110 is moved from the position “5” to the position “1” when the brake pedal is depressed, the shift range indicating lamp 140 shows a signal indicating the neutral N range. On the other hand, if the shift lever 110 is moved from the position “5” to the position “1” when the brake pedal is not depressed, the shift range indicating lamp 140 blinks to intermittently show a signal indicating the parking P range.

If the shift lever 110 is moved while the brake pedal is not depressed in other shift ranges (N, R, D), the shift range indicating lamp 140 continuously blinks to intermittently show the signal indicating the parking P range.

However, if the shift lever 110 is moved while the brake pedal is depressed in other shift ranges (N, R, D), the shift range indicating lamp 140 shows a signal indicating a corresponding shift range.

If the shift lever 110 is moved to the position “5” while the shift range indicating lamp 140 blinks to intermittently show the signal indicating the parking range, the shift range indicating lamp 140 stops blinking.

By moving the shift lever 110 from the position “1” to the position “5” via the positions “1B” and “3”, the shift range can be changed to the parking P range from the drive D range, the reverse R range, and the neutral N range. This change of the shift range can be performed only while the vehicle is stopped, and it can be realized by a program logic.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

The shifting device according to the embodiment of the present invention may increase stability of a shifting operation, and the shifting operation can be easily performed because the shifting device is disposed near the driving wheel. Furthermore, the size of the shifting device is relatively small, so it can be easily mounted.

1. A shifting device for a shift-by-wire system comprising:
a shift lever comprising a head portion and a shifting portion that is coupled to the head portion, the shifting portion being shifted into each of shift range positions, the shift lever configured to output a corresponding electric signal in response to a shifting of the shifting portion; and
a shift mode switch unit coupled to the head portion of the shift lever, the shift mode switch unit configured to change a shift mode according to a state of a connection to the shift lever.

2. The shifting device of claim 1, wherein the shift mode switch unit is provided with a park button for realizing a park-by-wire function.

3. The shifting device of claim 1, wherein the head portion of the shift lever is provided with a shift range indicating lamp showing a current shift range.
